(19) United States
(12) Patent Application Publication
(10) Pub. No.: US 2021/0215576 A1
(43) Pub. Date: Jul. 15, 2021

(54) FLUIDIC SENSORS TESTING

(71) Applicant: Hewlett-Packard Development Company, L.P., Spring, TX (US)

(72) Inventors: Eric T. Martin, Corvallis, OR (US); Rogelio Cicili, San Diego, CA (US); James Michael Gardner, Corvallis, OR (US)

(73) Assignee: Hewlett-Packard Development Company, L.P., Spring, TX (US)

(21) Appl. No.: 17/047,711

(22) PCT Filed: Jun. 30, 2018
(86) PCT No.: PCT/US2018/040512

§ 371 Date: Oct. 15, 2020

(51) Int. Cl. G01M 99/00; B05B 12/00

(52) U.S. Cl. CPC G01M 99/008; B05B 12/004

(57) ABSTRACT

Examples include a fluidic die. The fluidic die comprises a plurality of fluid actuators arranged in respective sets of fluid actuators. The fluidic die further includes a plurality of fluidic sensors, where the fluidic sensors are arranged in respective sets, and each respective fluidic sensor is disposed proximate a respective fluid actuator. The fluidic die further comprises a plurality of current sources including a respective current source for each respective set of fluidic sensors. Furthermore, the fluidic die comprises a fluidic sensor test node. For each respective set of fluidic sensors, the fluidic die comprises respective fluidic sensor test logic, where the respective fluidic sensor test logic for each respective set of fluidic sensors is coupled between the respective current source and the fluidic sensor test node to selectively connect each respective current source to the fluidic sensor test node.

### BACKGROUND

Fluid ejection dies may eject fluid drops via nozzles thereof. Nozzles may include fluid actuators that may be actuated to thereby cause ejection of drops of fluid through nozzle orifices of the nozzles. Some example fluidic dies may include sensors. Some example fluid ejection dies may be printheads, where the fluid ejected may correspond to ink.

### DRAWINGS

FIG. 1A is a block diagram that illustrates some components of an example fluidic die.

FIG. 1B is a block diagram that illustrates some components of an example fluidic die.

FIG. 2 is a block diagram that illustrates some components of an example fluidic die.

FIG. 3 is a block diagram that illustrates some components of an example fluidic die.

FIG. 4 is a block diagram that illustrates some components of an example fluid ejection device.

FIG. 5 is a flowchart that illustrates an example sequence of operations that may be performed by an example fluid ejection system.

FIG. 6 is a flowchart that illustrates an example sequence of operations that may be performed by an example fluid ejection system.

FIG. 7 is a flowchart that illustrates an example sequence of operations that may be performed by an example fluid ejection system.

FIG. 8 is a flowchart that illustrates an example sequence of operations that may be performed by an example fluid ejection system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DESCRIPTION

Examples of fluidic dies may comprise fluid actuators. The fluid actuators may include a piezoelectric membrane based actuator, a thermal resistor based actuator, an electrostatic membrane actuator, a mechanical/impact driven membrane actuator, a magneto-strictive drive actuator, or other such elements that may cause displacement of fluid responsive to electrical actuation. Fluidic dies described herein may comprise a plurality of fluid actuators, which may also be referred to as an array of fluid actuators. The fluid actuators may be arranged in respective sets of fluid actuators, where each such set of fluid actuators may be referred to as a “primitive” or a “firing primitive.”

Fluidic dies, as used herein, may correspond to a variety of types of integrated devices with which small volumes (e.g., picoliter volumes, nanoliter volumes, microliter volumes, etc.) of fluid may be pumped, mixed, analyzed, ejected, etc. Such fluidic dies may include fluid ejection dies, such as printheads, additive manufacturing distributor components, digital titration components, and/or other such devices with which volumes of fluid may be selectively and controllably ejected. Other examples of fluidic dies in include fluid sensor devices, lab-on-a-chip devices, and/or other such devices in which fluids may be analyzed and/or processed.

In example fluidic dies, a fluid actuator may be disposed in a fluid chamber, where the fluid chamber may be fluidically coupled to a nozzle. The fluid actuator may be actuated such that displacement of fluid in the fluid chamber occurs and such displacement may cause ejection of a fluid drop via an orifice of the nozzle. Accordingly, a fluid actuator disposed in a fluid chamber that is fluidically coupled to a nozzle may be referred to as a fluid ejector. Moreover, the fluidic component comprising the fluid actuator, fluid chamber, and nozzle may be referred to as a “drop generator.”

Some example fluidic dies comprise microfluidic channels. Microfluidic channels may be formed by performing etching, microfabrication (e.g., photolithography), micromachining processes, or any combination thereof in a substrate of the fluidic die. Some example substrates may include silicon based substrates, glass based substrates, gallium arsenide based substrates, and/or other such suitable types of substrates for microfabricated devices and structures. Accordingly, microfluidic channels, chambers, nozzles, orifices, and/or other such features may be defined by surfaces fabricated in the substrate of a fluidic die. Furthermore, as used herein a microfluidic channel may correspond to a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.). Example fluidic dies described herein may comprise microfluidic channels in which fluidic actuators may be disposed. In such implementations, actuation of a fluid actuator disposed in a microfluidic channel may generate fluid displacement in the microfluidic channel. Accordingly, a fluid actuator disposed in a microfluidic channel may be referred to as a fluid pump.

In example fluidic dies described herein, fluidic sensors may be disposed proximate fluid actuators such that the fluidic sensors may be used to sense fluid characteristics in chambers or microfluidic channels in which the fluid actuators are disposed. For example, some fluidic dies may include a fluidic sensor disposed proximate a fluid actuator, such that the fluidic sensor may be used to detect formation and collapse of a vapor bubble caused by the fluid actuator. In other examples, a fluidic sensor may be disposed proximate a fluid actuator, and the fluidic sensor may be sued to measure concentration of a pigment or other compound in a carrier fluid. In such examples, sensing various characteristics of fluids may be performed by electrical stimulation of a given fluidic sensor, and signal characteristics output by the given fluidic sensor may be measured and analyzed. Characteristics of fluid proximate the sensor (such as in contact with a surface of the sensor) may be determined based on the signal characteristics output by the fluidic sensor.

As a specific example, a fluidic sensor may measure a fluid property concurrent with activation of an associated fluid actuator. In examples where a fluid actuator is a thermal based fluidic actuator, the fluidic sensor may be used to sense a fluid property during formation and collapse of a vapor bubble caused by the fluid actuator. In other examples where the fluid actuator is a piezoelectric membrane based fluid actuator, the fluidic sensor may be used to sense a fluid property during actuation of the piezoelectric membrane that causes ejection or other movement of a quantity of fluid. In some examples, a fluidic sensor may include an impedance sensor to measure variations in the impedance associated with a fluid actuator. Based on the measured impedances, some examples may determine a condition of a nozzle and/or chamber associated with the fluid actuator. In other examples, other types of sensors can be used to measure characteristics associated with fluid actuators, chambers, or other flow structures due to formation of a vapor bubble or generation of a pressure wave.

In such examples, the fluidic sensors may be electrically connected to current or voltage sources with which to electrically stimulate the fluidic sensors when a measurement is desired. As described above, many components and features of a fluidic die may be formed via microfabrication processes at different locations of a fluidic die. As a result, such fluidic sensors and the conductive traces, nodes, and logic connecting the fluidic sensors to an electrical source (e.g., a current source) may exhibit variances in electrical characteristics. Accordingly, measurements made using the fluidic sensors of such fluidic dies may exhibit variances due to the noted variances in electrical characteristics.

Therefore, examples provided herein include fluidic sensor test logic for sets of fluidic sensors. Using the fluidic sensor test logic described herein, such examples may measure electrical characteristics of the conductive traces, nodes, and logic for respective sets of fluidic sensors. Based on such electrical characteristics, examples may determine scaling characteristics for sets of fluidic sensors, and such scaling characteristics may be used when determining fluid actuator characteristics using the fluidic sensors.

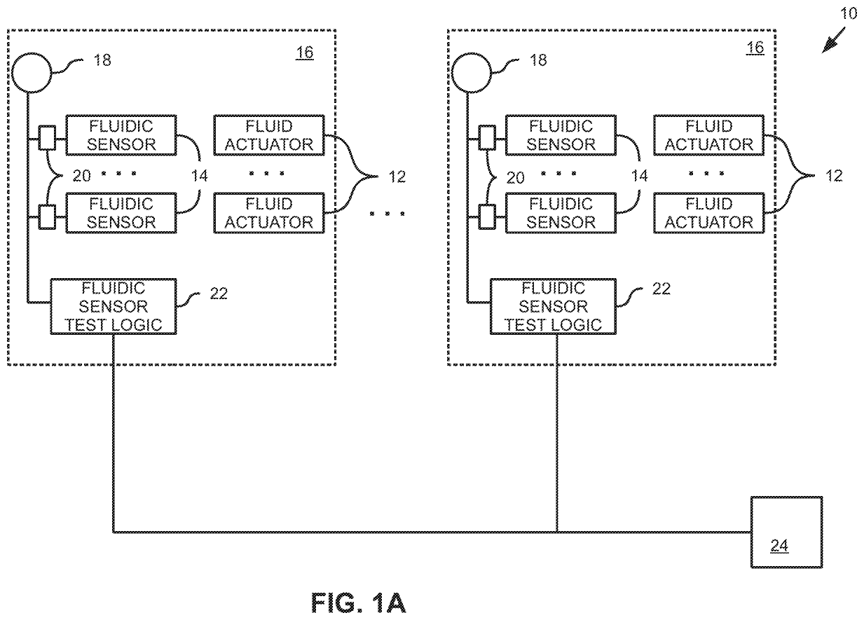

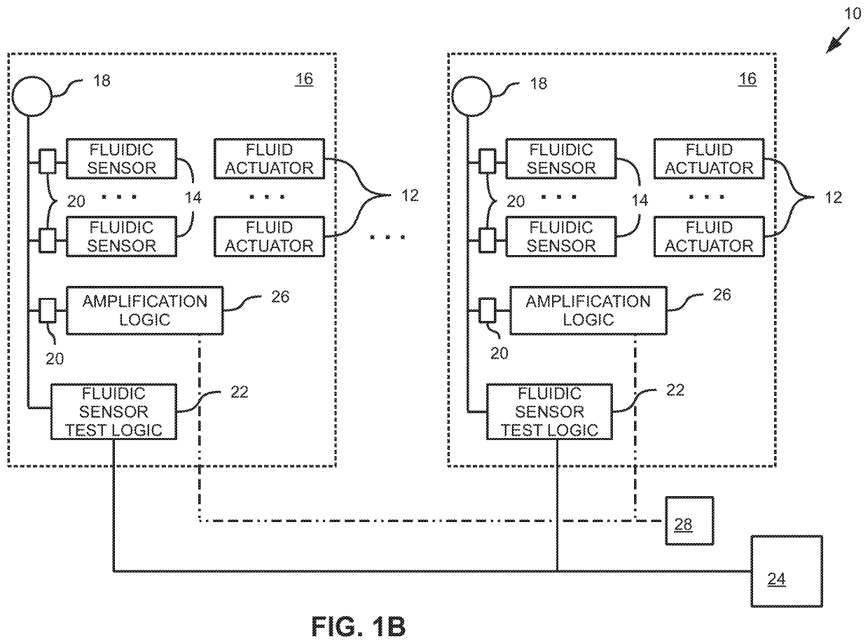

Turning now to the figures, and particularly to FIGS. 1A-B, these figures provide block diagrams of an example fluidic die 10. The fluidic die 10 includes a plurality of fluid actuators 12. Furthermore, the fluidic die 10 includes a plurality of fluidic sensors 14, where each fluidic sensor 14 is disposed proximate a fluid actuator 12. As shown, the fluid actuators 12 and fluidic sensors 14 are arranged in respective sets 16, where the sets 16 of fluid actuators 12 and the corresponding set of fluidic sensors 14 may be referred to as a primitive. As shown, the fluidic die 10 includes a plurality of current sources 18, where the die 10 includes a respective current source for each respective set 16 of fluidic sensors 14.

As shown, a respective current source 18 for a respective set 16 of fluidic sensors 14 may be connected to each fluidic sensor 14 through switch logic 20, such that each fluidic sensor 14 of the set 16 may be selectively connected to the respective current source 18 through the respective switch logic 20. Furthermore, for each respective set 16 of fluidic sensors 14, the fluidic die 10 includes respective fluidic sensor test logic 22 connected to the respective current source 18 of the set 16. The fluidic sensor test logic 22 of each respective set 16 is further connected to a fluidic sensor test node 24 of the fluidic die 10.

Accordingly, for the example fluidic die 10 illustrated in FIGS. 1A-B, current supplied by a respective current source 18 may be measured at the fluidic sensor test node 24 by connecting the respective current source 18 to the fluidic sensor test node 24 via the respective fluidic sensor test logic 22. By measuring the current output at the fluidic sensor test node 24, examples may determine evaluation scaling characteristics corresponding to the respective set 16 of fluidic sensors 14 based at least in part on the current output at the fluidic sensor test node 24. To address some of the variations noted above, examples may use the evaluation scaling characteristics associated with the respective set of fluidic sensors to scale fluidic sensor measurements and characteristics derived therefrom.

Furthermore, in FIG. 1B, the example fluidic die 10 includes respective amplification logic 26 for each respective set 16. As shown, the amplification logic is connected to the respective current source 18 of the respective set 16 to an amplification test node 28 via respective switch logic. By measuring voltage output at the amplification test node 28, examples may determine evaluation scaling characteristics corresponding to the respective set of fluidic sensors 14 based at least in part on the voltage output at the amplification test node 28.

In FIGS. 1A-B, the example fluidic die 10 is illustrated with two respective sets 16 of two fluid actuators 12 and two fluidic sensors 14 and other components. However, the simplification of the number of components is merely for clarity. As reflected with the repeating ellipses provided in FIGS. 1A-B for the various components and elements, examples such as the example fluidic die 10 of FIGS. 1A-B include more fluid actuators 12, fluidic sensors 14, respective sets 16, respective current nodes 18, respective fluidic sensor test logic 22, and/or respective amplification logic 26. For example, some fluidic dies may include more than 1000 fluid actuators and fluidic sensors arranged in more than 100 respective sets. As a particular example, some fluidic dies may comprise approximately 2,400 fluid actuators and fluidic sensors. As another example, some fluidic dies may comprise approximately 400 fluid actuators to approximately 1000 fluid actuators, and these fluidic dies may comprise approximately 200 fluidic sensors to approximately 1000 fluidic sensors. In such examples, the ratio of fluid actuators to fluidic sensors may be approximately 4:1 to approximately 1:1. In other examples, the ratio of fluid actuators to fluidic sensors may be greater than or less than 1:1.

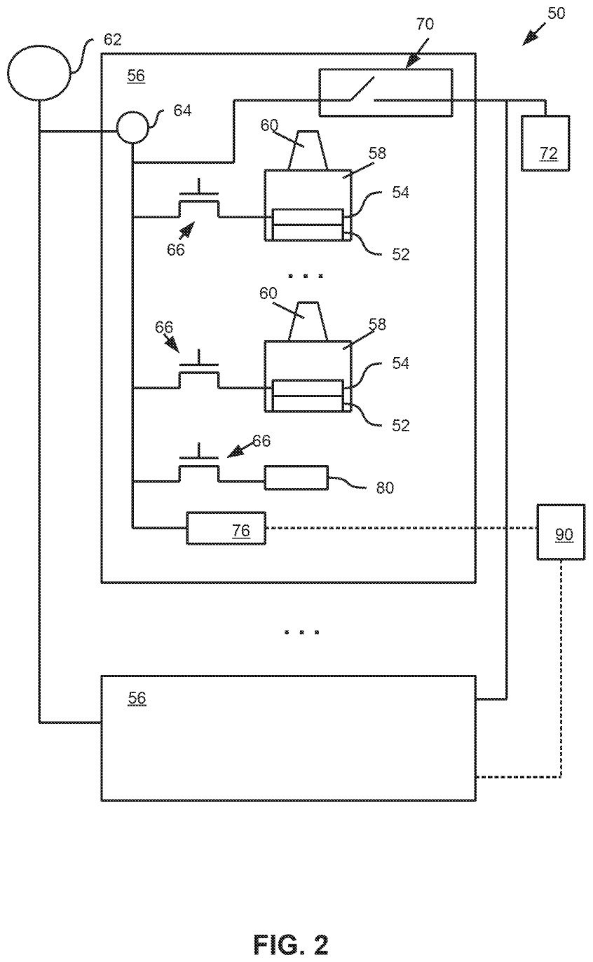

FIG. 2 provides a block diagram that illustrates an example fluidic die 50. In this example, the fluidic die 50 includes a plurality of fluid actuators 52 and a plurality of fluidic sensors 54, where the plurality of fluid actuators 52 and fluidic sensors 54 are arranged in respective sets 56. Notably, in FIG. 2, the components of one respective set 56 have been illustrated for clarity. It may be appreciated that other respective sets 56 have the same or similar arrangements of components.

In this example, the fluidic die 50 further includes fluid chambers 58 formed in the fluidic die 50, and the fluidic die 50 comprises nozzles 60 formed in the die 50, where each respective fluid chamber 58 may be fluidically coupled to a respective nozzle 60. As shown, a respective fluid actuator 52 is disposed proximate a respective fluid chamber 58. Accordingly, actuation of the respective fluid actuator 52 may cause displacement of fluid in the respective fluid chamber 58 such that a drop of fluid may be ejected via the respective nozzle 60. Furthermore, as shown in this example, the fluidic sensor 54 corresponding to each respective fluid actuator 52 is disposed as a layer over the fluid actuator 52.

The fluidic die 50 includes a die current source 62 that is connected to respective current sources 64 for each respective set 56. Accordingly, the respective current source 64 of each respective set 56 may correspond to a scaling current mirror that may output a scaled current based on a current output by the die current source 62. Accordingly, each die current source 62 may be referred to as a local sensing current source that corresponds to a respective set of fluidic sensors. The die current source 62 may further be referred to as a global current source. In turn, the respective current source 64 of each set 56 is connected to the respective fluidic sensors 54 via respective switch logic 66. In this example, it may be noted that the respective switch logic 66 comprises at least one field effect transistor (FET). Other examples may include other types of switch logic 66 to facilitate selectively connecting the respective current source 64 to a respective fluidic sensor 54 of the set 56.

Similar to other examples, the fluidic die 50 comprises respective fluidic sensor test logic 70 for each respective set 56, where the fluidic sensor test logic 70 is connected to the respective current source 64 of the respective set 56. In addition, the respective fluidic sensor test logic 70 of each respective set 56 is connected to a fluidic sensor test node 72 of the fluidic die 50. As shown in this example, the fluidic sensor test logic 70 may comprise at least one switch that may selectively connect the respective current source 64 of each respective set 56 to the fluidic sensor test node 72. In other examples, the fluidic sensor test logic 70 may comprise other arrangements of logical components to selectively connect a respective current source with the fluidic sensor test node 72.

Moreover, the fluidic die 50 includes, for each respective set 56, respective amplification logic 76. In this example, the amplification logic 76 may be coupled to the respective current source 64. Furthermore, the die 50 includes a current sink 80 coupled to the respective current source 64 via switch logic 78 in the form of a FET. In some examples, the current sink 80 may be a diode. The respective current source 64 may be selectively connected to the current sink 80, and the current sink 80 may generate a voltage that may be input into an amplifier 82 of the amplification logic 76. The output of the amplifier 82 may be coupled to an amplification test node 90. The output of the amplification logic 76 measured at the amplification test node 90 may be used to determine variation of the respective current source 64 and/or variation of the amplification logic 76.

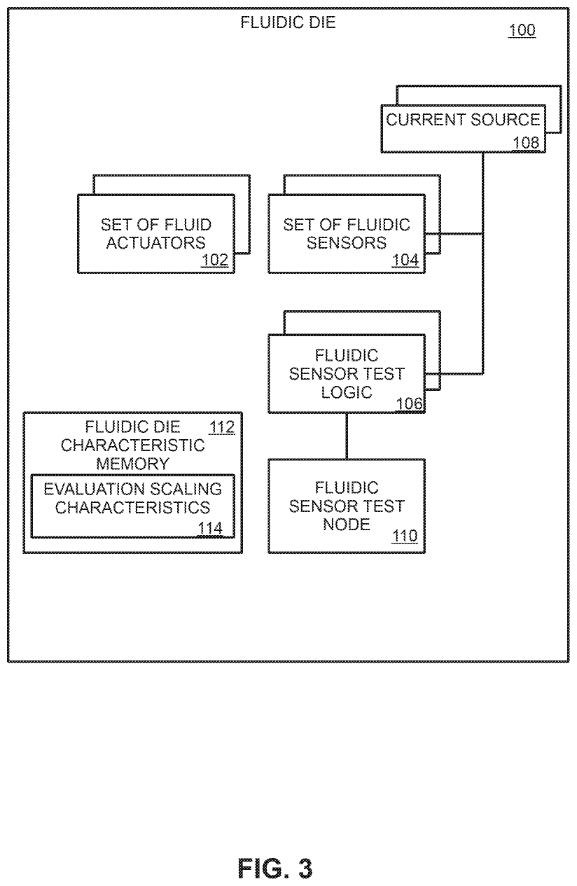

Turning now to FIG. 3, this figure provides a block diagram that illustrates some components of an example fluidic die 100. As described previously for other examples, the fluidic die 100 comprises sets of fluid actuators 102 and sets of fluidic sensors 104 disposed proximate the sets of fluidic actuators 102. For each set of fluidic sensors 104, the fluidic die 100 includes respective fluidic sensor test logic 106 and a respective current source 108. The fluidic sensor test logic 106 for each respective set of fluidic sensors 104 is connected to a fluidic sensor test node 110 on the die 100. Furthermore, in this example, the fluidic die 100 includes a fluidic die characteristic memory 112. As discussed previously, evaluation scaling characteristics 114 may be determined for the sets of fluidic sensors 104 such that later measurements with such fluidic sensors 104 may be adjusted to account for variations between measurement circuitry for fluidic sensor sets. Accordingly, in this example, the evaluation scaling characteristics 114 for each respective set of fluidic sensors 104 may be stored on the fluidic die characteristics memory 112.

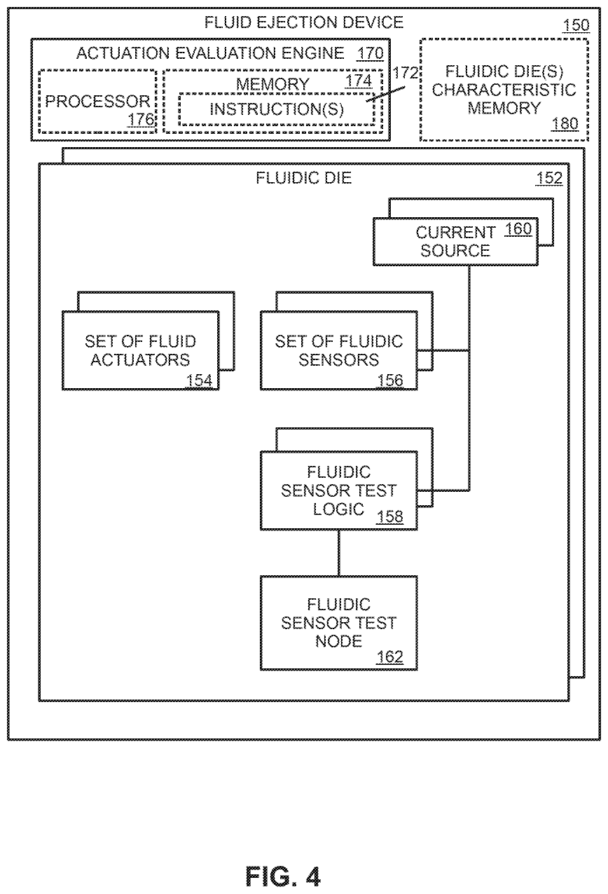

FIG. 4 provides a block diagram that illustrates some components of an example fluid ejection device 150. In this example, the fluid ejection device 150 includes a plurality of fluidic dies 152. Similar to other examples, each fluidic die 152 includes sets of fluid actuators 154 and sets of fluidic sensors 156, where a respective fluidic sensor of each set is positioned proximate a respective fluid actuator of each set. For each respective set, the fluidic die 152 comprises respective fluidic sensor test logic 158 and a respective current source 160. The respective current source 160 is connected to the respective set of fluidic sensors 156 and the respective fluidic sensor test logic 158. Furthermore, the fluidic sensor test logic 158 for each respective set of fluidic sensors 156 is connected to a fluidic sensor test node 162 of the fluidic die 152.

In this example, the fluid ejection device comprises an actuation evaluation engine 170. The evaluation engine 170 may be any combination of hardware and programming to implement the functionalities, processes, and/or sequences of operations described herein. In some examples, the combinations of hardware and programming may be implemented in a number of different ways. For example, the programming for the engine 170 may be processor executable instructions 172 stored on a memory 174 in the form of a non-transitory machine-readable storage medium, and the hardware for the engine may include a processor 176 to process and execute those instructions, Moreover, a process used to implement engines may comprise a processing unit (CPU), an application specific integrated circuit (ASIC), a specialized controller, and/or other such types of logical components that may be implemented for data processing.

In addition, similar to the example of FIG. 3, the fluid ejection device 150 may include a fluidic die characteristic memory 180. However, since the fluid ejection device 150 may include more than one fluidic die 152, the fluid ejection device 150 may store evaluation scaling characteristics corresponding to sets of fluidic sensors 156 for multiple fluid ejection dies 152.

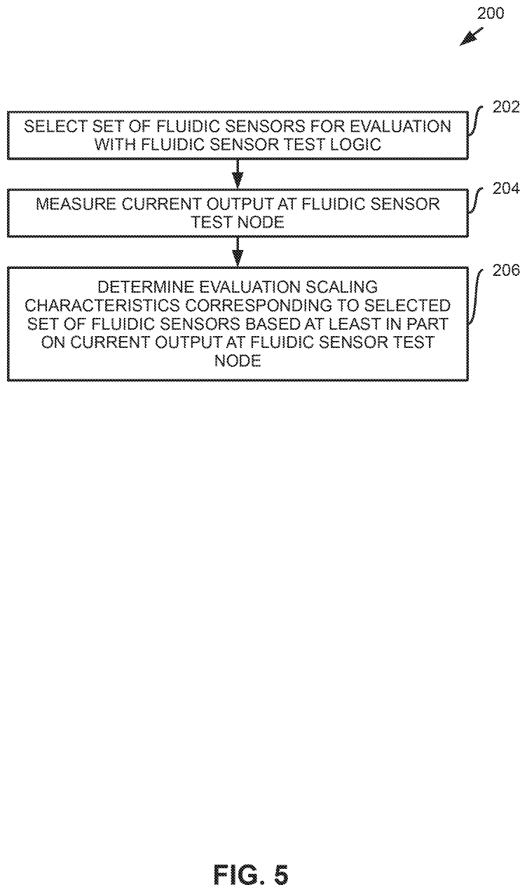

FIGS. 5-8 provide flowcharts that provide example sequences of operations that may be performed by an example fluidic die, fluid ejection device, engine, and/or a processing resource thereof to perform example processes and methods. In some examples, the operations included in the flowcharts may be embodied in a memory resource (such as the example memory 174 of FIG. 4) in the form of instructions that may be executable by a processing resource to cause an example fluid ejection device, fluidic die and/or an engine thereof to perform the operations corresponding to the instructions. Additionally, the examples provided in FIGS. 5-8 may be embodied in device, machine-readable storage mediums, processes, and/or methods. In some examples, the example processes and/or methods disclosed in the flowcharts of FIGS. 5-8 may be performed by one or more engines. Moreover, performance of some example operations described herein may include control of components and/or subsystems of a fluidic die and/or fluid ejection device by an engine thereof to cause performance of such operations. For example, ejection of fluid drops with a fluidic may include control of the fluidic die to cause such ejection of fluid drops.

Turning now to FIG. 5, this figure provides a flowchart 200 that illustrates an example sequence of operations that may be performed for an example fluidic die similar to the example fluidic dies described herein. As shown, for a fluidic die having a plurality of fluidic sensors arranged in sets as described in FIGS. 1-4, a respective set of fluidic sensors may be selected for evaluation with fluidic sensor test logic corresponding to the respective set of fluidic sensors (block 202). As discussed previously, selecting the respective set of fluidic sensors for evaluation may comprise selectively connecting a current source corresponding to the respective set of fluidic sensors to a fluidic sensor test node of the fluidic die via the fluidic sensor test logic corresponding to the respective set of fluidic sensors.

The current output at the fluidic sensor test node may be measured (block 204). The measured current at the output may be used to determine evaluation scaling characteristics corresponding to the selected set of fluidic sensors based at least in part on the current measured at the fluidic sensor test node (block 206).

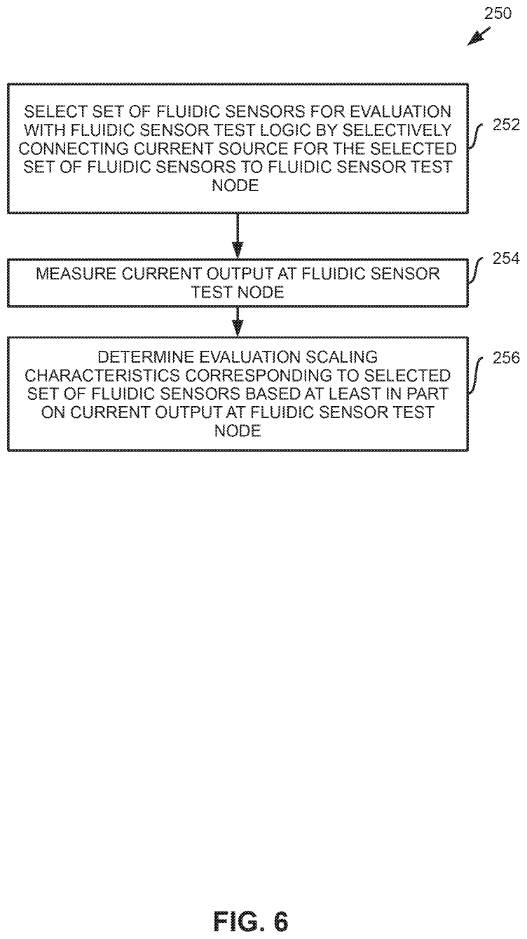

FIG. 6 provides a flowchart 250 that illustrates an example sequence of operations that may be performed for a fluidic die similar to the example fluidic dies described herein. In this example, a respective set of fluidic sensors may be selected for evaluation with fluidic sensor test logic corresponding to the respective set of fluidic sensors by selectively connecting a respective current source corresponding to the respective set of fluidic sensors to a fluidic sensor test node of the fluidic die (block 252). Current output at the fluidic sensor test node may be measured (block 254). Based at least in part on the current output at the fluidic sensor test node, evaluation scaling characteristics corresponding to the respective set of fluidic sensors may be determined (block 256).

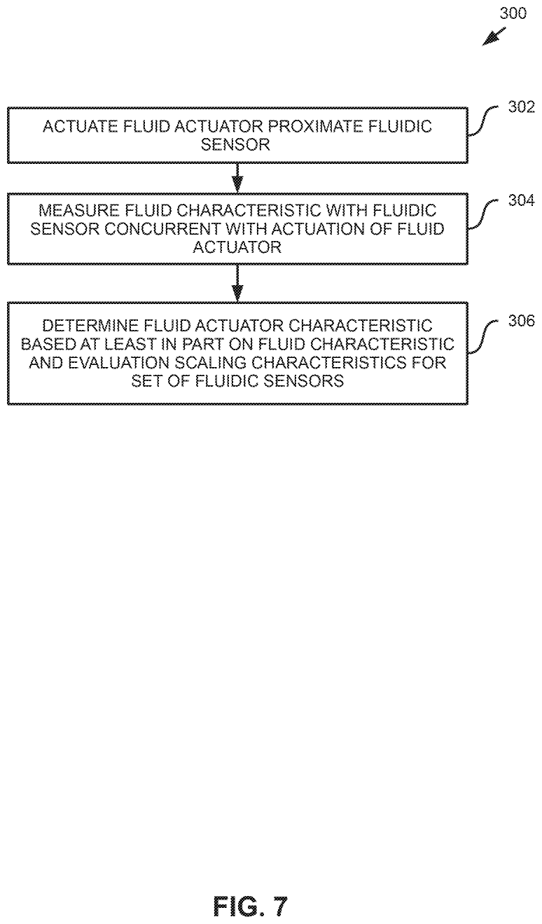

Turning now to FIG. 7, this figure provides a flowchart 300 that illustrates an example sequence of operations that may be performed for an example fluidic die. A particular fluidic actuator (proximate a particular fluidic sensor of a respective set of fluidic sensors) of a respective set of fluidic actuators of the fluidic die may be actuated (block 302). Using the proximate fluidic sensor, a fluid characteristic may be measured concurrent with actuation of the fluid actuator (block 304). Examples of fluid characteristics that may be measured include, for example, impedance, resistance, temperature, conductivity, composition, and/or other such characteristics. Based at least in part on the fluid characteristic and evaluation scaling characteristics corresponding to the respective set of fluidic sensors, examples may determine a fluid actuator characteristic corresponding to the particular fluid actuator (block 306).

For example, a thermal resistor based fluid actuator may be actuated, thereby causing a vapor bubble to form proximate the fluid actuator. Concurrent with actuation of the thermal resistor based fluid actuator, examples may measure an impedance with a fluidic sensor proximate the thermal resistor. The measured impedance may change during the formation and collapse of the vapor bubble. Based on the measured impedance, and the measured changes thereof, the example die may determine a condition of the fluid actuator. For example, a fluid actuator characteristic to be determined may be whether the fluid actuator is operating or non-operating. As another example, a fluid actuator characteristic to be determined may be whether the fluid actuator is generating a desired vapor bubble size or whether the fluid actuator is causing a vapor bubble to form at a correct time.

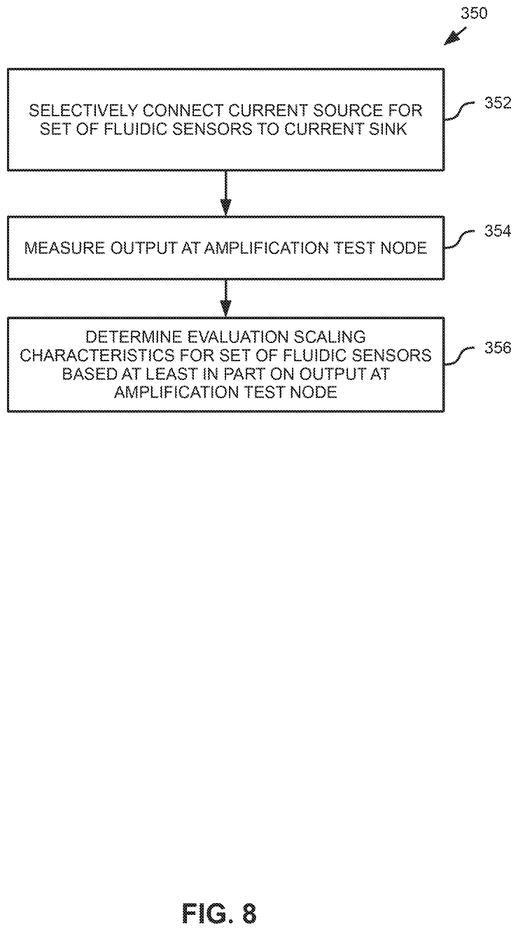

FIG. 8 provides a flowchart 350 that illustrates an example sequence of operations that may performed for an example fluidic die. In this example, a respective current source corresponding to a respective set of fluidic sensors may be selectively coupled to a current sink (block 352) corresponding to the respective set of fluidic sensors (block 352). Output at the amplification test node may be measured (block 354). Based at least in part on the output at the amplification test node, evaluation scaling characteristics corresponding to the set of fluidic sensors may be determined (block 356). Therefore, examples similar to the examples of FIG. 8 may measure an output at the amplification test node to determine characteristics associated with components of amplification logic corresponding to a respective set of fluidic sensors. In some examples, the measured output may correspond to a voltage. In such examples, measurements made with the respective set of fluidic sensors may be scaled based at least in part on the determined characteristics of the amplification logic of the respective set of fluidic sensors.

In some examples, evaluation scaling characteristics for an example set of fluidic sensors may be determined based at least in part on the following equation:

$${scalar}_{prim [ i ]} = [ 1 - \frac{offset \{ {isrc}_{prim [ i ]} \}}{\begin{matrix}offset \{ {isrc}_{prim [ i ]} \} + \\ slope \{ {isrc}_{prim [ i ]} \} {isrc}_{top ( meas )}\end{matrix}} ] [ \frac{slope \{ {isrc}_{prim ( ideal )} \}}{slope \{ {isrc}_{prim [ i ]}} ] \qquad ( 1 )$$

In this example, offfset{isrc_{prim[i]}} corresponds to the measured offset current of the local sensing current source for the respective set of fluidic sensors and the ideal value may be zero. Furthermore, slope{isrc_{prim[i]}} corresponds to the measured slope of the local sensing current source for the set of fluidic sensors and the ideal value is the 1:n ratio of the local sensing current mirror biased by the global current source. Moreover, isrc_{top{meas}} corresponds to the measured current provided by the global biasing current source, where this value depends on the setting.

Accordingly, examples provided herein facilitate adjustments of fluidic sensors measurements to account for variations of components corresponding to the fluidic sensor sets. The preceding description has been presented to illustrate and describe examples of the principles described. This description is not intended to be exhaustive or to limit these principles to any precise form disclosed. Many modifications and variations are possible in light of the description. In addition, while various examples are described herein, elements and/or combinations of elements may be combined and/or removed for various examples contemplated hereby. For example, the operations provided herein in the flowcharts of FIGS. 5-8 may be performed sequentially, concurrently, or in a different order. Moreover, some example operations of the flowcharts may be added to other flowcharts, and/or some example operations may be removed from flowcharts. In addition, the components illustrated in the examples of FIGS. 1-4 may be added and/or removed from any of the other figures. Therefore, the foregoing examples provided in the figures and described herein should not be construed as limiting of the scope of the disclosure, which is defined in the Claims.

1. A fluidic die comprising:
a plurality of fluid actuators arranged in respective sets of fluid actuators;
a plurality of fluidic sensors, the fluidic sensors arranged in respective sets of fluidic sensors such that each respective fluidic sensor of a respective set of fluidic sensors is disposed proximate a respective fluid actuator of a respective set of fluidic actuators;
a plurality of current sources including a respective current source for each respective set of fluidic sensors;
a fluidic sensor test node; and
respective fluidic sensor test logic for each respective set of fluidic sensors, each respective fluidic sensor test logic coupled between the fluidic sensor test node and each respective current source to selectively connect each respective current source to the fluidic sensor test node.

2. The fluidic die of claim 1, further comprising:
an amplification logic test node; and
respective amplification logic for each respective set of fluidic sensors, the respective amplification logic coupled between the amplification logic test node and each respective current source of each respective set of fluidic sensors.

3. The fluidic die of claim 2, further comprising:
a respective current sink for each respective set of fluidic sensors, each respective current sink to input a voltage to the respective amplification logic of each respective set of fluidic sensors.

4. The fluidic die of claim 1 further comprising:
a plurality of nozzles; and
a plurality of fluid ejection chambers including at least one respective fluid ejection chamber fluidically coupled to each respective nozzle of the plurality of nozzles wherein at least some of the plurality of fluid actuators are disposed in fluid ejection chambers of the plurality of fluid ejection chambers.

5. The fluidic die of claim 1, wherein the fluidic sensor test logic coupled between the fluidic sensor test node and each respective current source of each respective set of fluidic sensors comprises at least one respective test enable switch for each respective set of fluidic sensors.

6. The fluidic die of claim 1, further comprising:
a fluidic die characteristic memory to store evaluation scaling characteristics for each set of fluidic sensors, the evaluation scaling characteristics determined based at least in part on current output at the fluidic sensor node via each respective fluidic sensor test logic.

7. A method for a fluidic die, the fluidic die comprising a plurality of fluid actuators arranged in sets of fluid actuators, the fluidic die further comprising a plurality of fluidic sensors arranged in sets of fluidic sensors, respective fluidic sensors of the plurality of fluidic sensors disposed proximate respective fluid actuators of the plurality of fluid actuators, the method comprising:
selecting, with fluidic sensor test logic, a respective set of fluidic sensors of the fluidic die for evaluation;
measuring current output at a fluidic sensor test node; and
determining evaluation scaling characteristics corresponding to the respective set of fluidic sensors selected for evaluation based at least in part on the current output at the fluidic sensor test node.

8. The method of claim 7, wherein selecting the respective set of fluidic sensors for evaluation comprises:
selectively connecting, with the fluidic sensor test logic, a respective current source corresponding to the respective set of fluidic sensors to the fluidic sensor test node.

9. The method of claim 7, further comprising:
concurrent with actuating a respective fluid actuator proximate a respective fluidic sensor of the respective set of fluidics sensors, measuring a fluid characteristic with the respective fluidic sensor; and
determining a fluid actuator characteristic based at least in part on the fluid characteristic and the evaluation scaling characteristics corresponding to the respective set of fluidic sensors.

10. The method of claim 7, further comprising:
selectively connecting, with the fluidic sensor test logic, the respective current source corresponding to the respective set of fluidic sensors to a current sink; and
measuring output at the amplification logic test node, wherein the evaluation scaling characteristics corresponding to the respective set of fluidic sensors is determined based at least in part on the current output at the amplification logic test node.

11. A fluid ejection device comprising:
a fluidic die comprising:
a plurality of fluid actuators arranged in respective sets of fluid actuators;
a plurality of fluidic sensors, the fluidic sensors arranged in respective sets of fluidic sensors such that each respective fluidic sensor of a respective set of fluidic sensors is disposed proximate a respective fluid actuator of a respective set of fluidic actuators;
a plurality of current sources including a respective current source coupled to each respective set of fluidic sensors; and
an actuation evaluation engine to:
determine fluid actuator characteristics for a respective fluid actuator of the plurality based at least in part on fluidic sensor characteristic of the respective fluidic sensor disposed proximate the respective fluid actuator and evaluation scaling characteristics corresponding to the respective set of fluidic sensors in which the respective fluidic sensor is arranged.

12. The fluid ejection device of claim 11, wherein the fluid ejection device comprises a fluidic die characteristic memory to store evaluation scaling characteristics for each respective set of fluidic sensors.

13. The fluid ejection device of claim 11, wherein the fluidic die comprises:
a fluidic sensor test node; and
respective fluidic sensor test logic for each respective set of fluidic sensors, each respective fluidic sensor test logic coupled between the fluidic sensor test node and each respective current source of each respective set of fluidic sensors to selectively connect each respective set of fluidic sensors to the fluidic sensor test node.

14. The fluid ejection device of claim 13, wherein the evaluation scaling characteristics corresponding to the respective set of fluidic sensors in which the respective fluidic sensor is arranged are based at least in part on current output at the fluidic sensor test node when the respective set of fluidic sensors are selectively coupled, via the respective fluidic sensor test logic, to the fluidic sensor test node.

15. The fluid ejection device of claim 13, wherein the fluidic die further comprises:
an amplification test node; and
respective amplification logic for each respective set of fluidic sensors, the respective amplification logic coupled between the amplification test node and each respective current source of each respective set of fluidic sensors.
